(19) United States
(12) Patent Application Publication
(10) Pub. No.: US 2026/0105203 A1
(43) Pub. Date: Apr. 16, 2026

(54) TECHNIQUES FOR INCORPORATING MATERIALS INTO BUILDING ASSEMBLY DESIGNS

(71) Applicant: AUTODESK, INC., San Francisco, CA (US)

(72) Inventors: Allin Irving GROOM, Edinburgh (GB); Dale ZHAO, New York City, NY (US); Arthur HARSUVANAKIT, Berkeley, CA (US); David BENJAMIN, Brooklyn, NY (US); Brian LEE, San Francisco, CA (US); Shu ZHONG, San Francisco, CA (US); Bon Adriel ASENIERO, Toronto (CA)

(21) Appl. No.: 19/193,433

(22) Filed: Apr. 29, 2025

Related U.S. Application Data
(60) Provisional application No. 63/708,173, filed on Oct. 16, 2024.

(51) Int. Cl. G06F 30/13; G06F 30/27; G06F 111/02

(52) U.S. Cl. CPC G06F 30/13; G06F 30/27; G06F 2111/02

(57) ABSTRACT

One embodiment sets forth a technique for incorporation material into building assembly designs. According to some embodiments, the technique can include the steps of receiving first input data that defines a building assembly design, wherein the building assembly design includes at least one material layer; generating, via at least one generative artificial intelligence (AI) model, an assembly graph based on the input data, wherein the assembly graph describes at least one relationship associated with the at least one material layer; receiving second input data that describes at least one constraint for generating an updated building assembly design; generating, via the at least one generative AI model, the updated building assembly design based on the at least one constraint and the assembly graph; and displaying, via at least one user interface, information associated with the updated building assembly design.

### CROSS-REFERENCE TO RELATED APPLICATIONS

The present application claims the benefit of U.S. Provisional Application titled, “TECHNIQUES FOR INCORPORATING MATERIALS INTO BUILDING ASSEMBLY DESIGNS USING KNOWLEDGE GRAPHS AND LANGUAGE MODELS,” filed on Oct. 16, 2024, and having Ser. No. 63/708,173. The subject matter of this related application is hereby incorporated herein by reference.

### BACKGROUND

### Field of the Various Embodiments

Embodiments of the present disclosure relate generally to computer science, artificial intelligence, complex software applications, and, more specifically, to techniques for incorporating materials into building assembly designs.

### Description of the Related Art

Buildings are composed of complex assemblies of material layers that are engineered to meet specific performance functions, regional requirements, and project objectives. As building projects must satisfy evolving requirements—ranging from sustainability and cost efficiency, to performance and aesthetic appeal—architects and building designers face the challenge of integrating numerous material layers into unified and effective designs. As a result, meeting design requirements calls for streamlined methodologies that can intelligently balance intricate trade-offs that are inherent in selecting material layers for building designs.

Currently, conventional methods for selecting material layers rely on extensive research, disparate software tools, and domain expertise. For example, designers often consult multiple external data sources and engage with diverse specialists to identify materials that fulfill performance criteria, such as sustainability mandates. In some cases, designers find themselves constrained by standard assemblies that have become the industry norm for managing complexity, risk, and compliance with budget, schedule, and regional requirements. These standard assemblies typically favor materials that are more wasteful, non-geo-specific, and carbon-intensive. As a result, any material change to such standard assemblies can trigger cascading effects on the overall performance of a building.

One drawback of conventional approaches is that the material layer selection process is inherently error-prone and demands a high level of specialized knowledge. In particular, the assessment of feasibility of material layers for a given building assembly design relies on knowledge from experienced consultants and material specialists, thereby necessitating extensive research and added effort that may exceed the typical skillsets of architects. Moreover, because identifying appropriate materials for individualized, personalized assemblies involves balancing a wide array of trade-offs such as function, availability, cost, and sustainability, even minor miscalculations can compromise the integrity of the final design. Such a process forces designers to undertake exhaustive evaluations and corrections from a variety of sources, which increases the potential for errors and hinders design workflows.

Another drawback of conventional approaches is that integrating multiple software applications that contain the data required to make informed decisions about material layer selections presents various technical challenges. For example, the need to interface with various platforms, databases, and expert systems requires designers to manage fragmented information flows and reconcile with disparate data sources. This lack of integration complicates decision-making, and necessitates ongoing expert consultation and manual cross-referencing. As a result, each individualized building project becomes a uniquely complex endeavor, thereby limiting the scalability and accuracy of overall design processes.

As the foregoing illustrates, what is needed in the art are more effective techniques for incorporating materials into building assembly designs.

### SUMMARY

One embodiment sets forth a method for incorporating materials into building assembly designs. According to some embodiments, the method includes the steps of receiving first input data that defines a building assembly design, wherein the building assembly design includes at least one material layer; generating, via at least one generative artificial intelligence (AI) model, an assembly graph based on the first input data, wherein the assembly graph describes at least one relationship associated with the at least one material layer; receiving second input data that describes at least one constraint for generating an updated building assembly design; generating, via the at least one generative AI model, the updated building assembly design based on the second input data and the assembly graph; and displaying, via at least one user interface, at least a portion of the updated building assembly design.

One technical advantage of the disclosed techniques relative to the prior art is that the disclosed techniques can help reduce errors in the building design process by aiding in the research process. In particular, by suggesting materials, layouts, etc., that meet user-defined requirements, the disclosed techniques enable designers to accurately balance a wide variety of trade-offs, functions, and restrictions inherent in managing building assembly designs. Another technical advantage is that the disclosed techniques enable more informed evaluations of material layers against design constraints, including performance, sustainability, and regulatory compliance, which can help reduce the risks involved in error-prone manual research. Another technical advantage is that the disclosed techniques consolidate helpful knowledge into a single, integrated system. Such integration enables designers to work independently without relying on external experts or additional resources, as the integrated system maintains relevant material data and expertise. By aggregating information from multiple databases, industry standards, and design inputs, the integrated system simplifies and increases the accuracy of decision-making and design processes by making the knowledge required for informed material layer selection available through a centralized platform.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of various embodiments.

FIG. 2A illustrates a workflow diagram for incorporating materials into building assembly designs, according to various embodiments.

FIG. 2B illustrates more detailed view of the workflow diagram of FIG. 2A, according to various embodiments.

FIG. 3A-3D illustrate conceptual diagrams of user interfaces associated with a software application executing on one of the endpoint devices of FIG. 1, according to various embodiments.

FIG. 4 sets forth a flow diagram of method steps for techniques for incorporating materials into building assembly designs, according to various embodiments.

FIG. 5 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

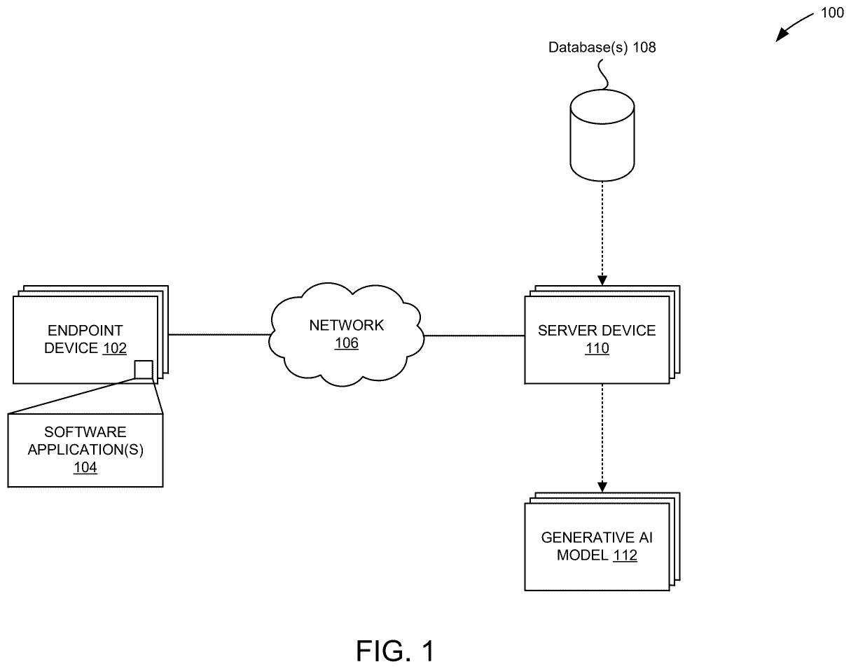

FIG. 1 is a block diagram of a system 100 configured to implement one or more aspects of the various embodiments. As shown, the system 100 includes at least one endpoint device 102, at least one server device 110, at least one database 108, and at least one generative AI model 112, which can communicate between one another via a communications network 106. The communications network 106 can represent, for example, any technically feasible network or number of networks, including a wide area network (WAN) such as the Internet, a local area network (LAN), a Wi-Fi network, a cellular network, or a combination thereof.

According to some embodiments, an endpoint device 102 can represent a computing device (e.g., a desktop computing device, a laptop computing device, a mobile computing device, etc.). As shown in FIG. 1, at least one software application 104 can be installed on and execute on the endpoint device 102. The software application 104 can represent, for example, a web browser application, a web browser application extension, a productivity application, etc., that enables information for building assembly designs to be created, imported, etc., as well as modified, interacted with, etc., in accordance with the techniques described herein. In one example, the software application 104 represents a software application for generating, editing, etc., computer-aided design (CAD) files that incorporate building assembly designs.

According to some embodiments, the software application 104 can be configured to facilitate data collections, user interactions, etc., to enable the software application 104 and/or the server device 110 to implement the various techniques described herein. In particular, the software application 104 can collect and transmit input data required by the server device 110. In turn, the server device 110 can transmit output data to the software application 104, at which point the software application 104 can display the output data and enable the user to interact with the output data (e.g., via one or more user interfaces). It should be appreciated that, in some embodiments the software application 104 can implement the techniques herein independent from the server device 110, consistent with the scope of this disclosure.

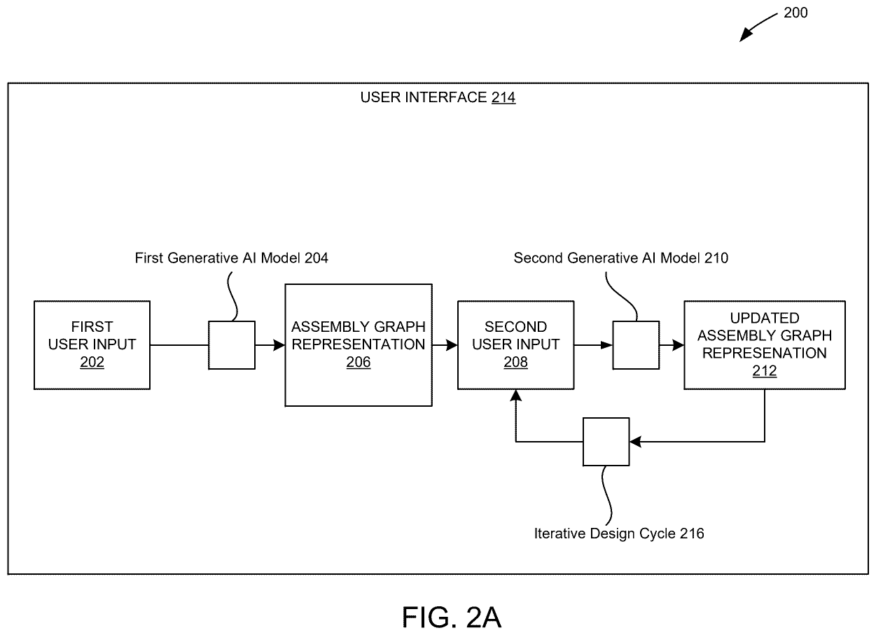

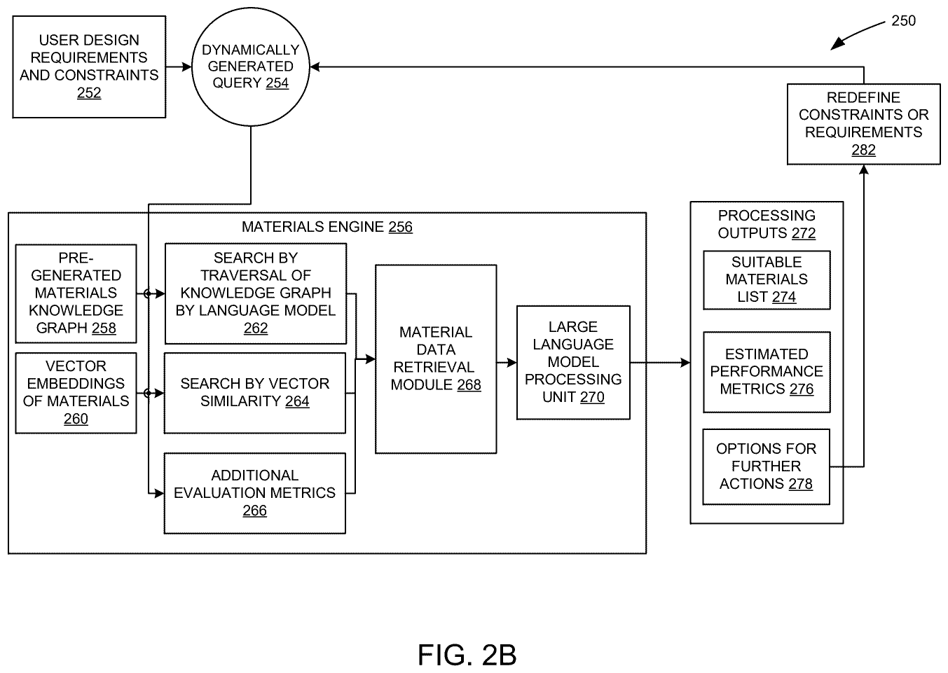

According to some embodiments, the generative AI models 112 can represent one or more trained machine learning models. For example, the generative AI models 112 can be implemented as large language models, computer vision models, graph neural networks, or other advanced architectures. As described in greater detail below in conjunction with FIGS. 2A-2B, the generative AI models 112 can be trained to generate assembly graph representations, material search queries, and so on. The generative AI models 112 can also be configured to convert abstract data types between different formats.

As described herein, the software application 104 and the server device 110 can enable users to incorporate building materials into building assembly designs. FIG. 2A illustrates a workflow diagram 200 that is implemented as a user interacts with the software application 104 to carry out an iterative design cycle 216. As shown in FIG. 2A, different user inputs, including a first user input 202 and a second user input 208, can be received by the software application 104 via a user interface 214.

According to some embodiments, the first user input 202 and a second user input 208—which are collectively represented as user design requirements and constraints 252 illustrated in FIG. 2B—can include any information that effectively defines a building assembly design. The information can be provided, for example, in the form of drawings that define an assembly, text that defines an assembly, a video that defines an assembly, a data file that defines an assembly, or the like. The information can define, for example, components of an assembly, standards and precedence associated with the assembly, building codes and regulations associated with the assembly, design constraints such as existing construction or acoustic requirements associated with the assembly, design intents associated with the assembly (e.g., climate conditions, carbon considerations, desired materials, etc.), project goals, or the like. It is noted that the foregoing examples are not meant to be limiting, and that the information can include any amount, type, form, etc., of information that effectively describes designs, properties, considerations, etc., of a building assembly design, at any level of granularity, consistent with the scope of this disclosure.

As shown in FIG. 2A, a first step of the workflow diagram 200 involves the user inputting the first user input 202, which includes information associated with a building assembly design. Server device 110 then generates, using a generative AI model 204, an assembly graph representation 206 of the building assembly design based on the user input 202. If the user input 202 contains specific materials, then the specific materials are incorporated into the assembly graph representation 206. Alternatively, if no specific materials are contained in the user input 202, then the generative AI model 204 can generate materials based on design constraints that are specified by the user (e.g., in the form of information input by the user via the user interface 214). For example, for a building assembly design that includes a wall, the design constraints can specify that the wall should include, in an order from interior to exterior, a drywall layer, an insulation layer, a wood frame layer, a moisture barrier layer, a wire layer, and a stucco layer. It is noted that the foregoing example is not meant to be limiting, and that the design constraints can include any amount, type, form, etc., of information, at any level of granularity, consistent with the scope of this disclosure.

After the assembly graph representation 206 is generated, the user can interact with the assembly graph representation 206 to inspect information available via the assembly graph representation 206, as described in greater detail below. The user can then provide the second user input 208. A second generative AI model 210 can use the second user input 208, along with suggested materials further described below, to generate an updated assembly graph representation 212. Through the iterative design cycle 216, the user can continue to provide additional second user inputs 208 that allow for generations and further refinements of the updated assembly graph representation 212.

According to some embodiments, the assembly graph representation 20—as well as the updated assembly graph representation 212, described below in greater detail—each provide a structured representation of a given building assembly design that visually and logically illustrates the relationships between individual material layers and functional attributes associated with the building assembly design. Specifically, a given assembly graph can include different types of nodes, including material nodes and functional nodes. According to some embodiments, a material node represents a material included in the building assembly design. Material nodes within the assembly graph are interconnected to represent relationships between different materials. For example, relationships between different materials can be depicted by edges connecting respective material nodes, which visually indicate dependencies, interactions, or combined functional properties of materials within the building assembly design. According to some embodiments, functional nodes may be dynamically generated based on the collective properties and interconnected relationships of individual material nodes. The functional nodes can represent properties or performance characteristics of the building assembly design, such as fire resistance, thermal insulation, acoustic performance, structural integrity, or other desired functional outcomes resulting from the combination of selected materials and the arrangement of the materials in layers. It is noted that the foregoing examples are not meant to be limiting, and that the assembly graphs discussed herein can include any number, type, form, etc., of node(s), which can be configured to store any amount, type, form, etc., of information, and can be interconnected using any number, type, form, etc., of connections, at any level of granularity, consistent with the scope of this disclosure.

According to some embodiments, the assembly graphs can be automatically converted or translated into alternative representations that support the user in understanding how individual materials or groups of materials affect the overall building assembly design. For example, the alternative representations can include drawing views or other visualization formats, structured data outputs that specify metrics or performance characteristics of the overall building assembly design, such as a list, and the like. It is noted that the foregoing examples are not meant to be limiting, and that the assembly graphs can be converted into any number, type, form, etc., of alternative representation(s), at any level of granularity, consistent with the scope of this disclosure.

According to some embodiments, the assembly graphs serve as interactive tools that enable structured design cycles to be carried out. Users can interact directly with the assembly graphs through the user interface 214 to inspect individual nodes or groups of nodes to obtain detailed information associated with each node, including material properties, functional characteristics, and so on. Interaction with a particular node provides the user with insights regarding the contribution of the particular node to the overall building assembly design and the relationship of the node with other nodes.

According to some embodiments, the software application 104 can identify nodes (i.e., materials, functions, etc.) that exert a threshold level of influence on the overall performance of the assembly graph representation 206 and/or the updated assembly graph representation 212 (i.e., the building assembly design), as determined by the user design requirements and constraints 252. For example, different properties of the nodes can be adjusted, such as the size, shape, color, or other graphical indicators, based on specific metrics or functional characteristics associated with the nodes. By visually differentiating specific nodes, software application 104 effectively highlights nodes (i.e., materials) that impact the overall performance of the building assembly design, which can function as recommendations for adding, modifying, removing, etc., specific materials based on the user design requirements and constraints 252.

According to some embodiments, when a given node is selected, the software application 104 provides (e.g., via the user interface 214) detailed information about the selected node, including material properties, functions, and the contributions of the node to overall building assembly design, performance criteria, and so on. For example, a user may click on a material node within the user interface 214 and activate a user interface element (e.g., button, menu selection, etc.) to initiate a request for additional information about the material represented by the material node, alternative materials that can be used, and so on. It is noted that the foregoing examples are not meant to be limiting, and that the user interface 214 can display any amount, type, form, etc., of information associated with one or more nodes, at any level of granularity, consistent with the scope of this disclosure.

FIG. 2B illustrates a workflow diagram 250 that depicts a more detailed view of the workflow diagram 200 illustrated in FIG. 2A, according to some embodiments. In particular, FIG. 2B highlights specific internal processes that enable the updated assembly graph representation 212 to be generated and then displayed via the user interface 214. As shown in FIG. 2B, in the workflow diagram 250, user design requirements and constraints 252 are received from the user—which, as previously described herein, can represent at least one of the first user input 202 or the second user input 208. Prior to generating material suggestions, as described in greater detail below, the user can be prompted for optional second user input 208 to further constrain or define the building assembly design. As the design process can be cyclical, the user can also input elements from processing outputs 272 that were generated in a previous iteration of the design process, if available.

As previously described above in conjunction with FIG. 2A, the second generative AI model 210 can receive the second user input 208, the assembly graph representation 206, suggested materials information, etc., to generate an updated assembly graph representation 212. As shown in FIG. 2B, to provide suggested materials information, the software application 104 can, in response to the user request for alternative materials, convert user design requirements and constraints 252 to a dynamically generated query 254 using one or more of the generative AI models 112. As shown in FIG. 2B, the dynamically generated query 254 can be provided to materials engine 256, which can be used by the materials engine 256 to search for suggested materials using a large language model processing unit 270 to generate a suitable materials list 274. According to some embodiments, suitable materials list 274 includes a set of suggested materials and is stored in processing outputs 272, as described in greater detail below.

As described herein, the generative AI models 112 convert the user design requirements and constraints 252 into the dynamically generated query 254, which can include a variety of data structures that store specific material properties to be searched for, analyzed, etc., by the materials engine 256. According to some embodiments, the dynamically generated query 254 stores information about the specific material properties in a format that the materials engine 256 can use to search various material data sets that are accessible to the materials engine 256. Dynamically generated query 254 is then used by materials engine 256 to generate processing outputs 272. The user then has the ability to view processing outputs 272, and provide redefined constraints or requirements 282.

According to some embodiments, the suitable materials list 274 can be arranged in a sequential order such that a first entry corresponds to the material deemed most relevant based on one or more user-defined constraints, and subsequent entries can follow in a descending order of relevance. For each suggested material in the suitable materials list 274, the user can access detailed information, such as material types, product information, product specifications, associated metrics (e.g., cost, availability, sourcing details), physical and functional properties, compatibility assessments, interactive links, references to external resources for obtaining additional details, procurement options, and so on. It is noted that the foregoing examples are not meant to be limiting, and that the suitable materials list 274 can include any amount, type, form, etc., of information, at any level of granularity, consistent with the scope of this disclosure.

According to some embodiments, software application 104 allows the user to view how suggested alternative materials will impact different metrics of the building assembly design, including performance, cost-effectiveness, and compliance with specified design constraints. After reviewing the detailed information, the user may choose to accept and substitute a prior material with one or more of the suggested alternative materials. Upon confirmation, the second generative AI model 210 generates the updated assembly graph representation 212 to reflect changes that have been made to the materials. The updated assembly graph representation 212 can then be displayed via the user interface 214.

Through the iterative design cycle 216, the user can interact with the user interface 214 to implement further changes (if needed) to the building assembly design. More specifically, the user may provide additional second user inputs 208—which are illustrated in FIG. 2B as redefined constraints or requirements 282—to generate additional updated assembly graph representations 212.

According to some embodiments, software application 104 is configured to store successive iterations of updated assembly graph representation 212 to enable the user to view and revert to any previously generated version of the building assembly design. The functionality enables the user to review historical assembly graph representations, facilitate restoration of earlier design configurations, make comparisons, etc., as needed by the user.

According to some embodiments, user design and requirements constraints 252 can include information that corresponds to preexisting materials within a building assembly design, requests for suggested materials, specific constraints that mandate materials with particular functions, and so on. Generative AI model 112 can convert the user design and requirements and constraints 252 to a dynamically generated query 254. In this specific context, generative AI model 112 is trained to convert the user design requirements and requirements 252 into the dynamically generated query 254. The dynamically generated query 254 is constructed to provide better context for the materials engine 256. The dynamically generated query 254 is then passed to materials engine 256, such that materials engine 256 has the pre-requisite data to search for different materials.

In one example, the user design requirements and constraints 252 can include the input text “I need an exterior finish material that is sustainable and has acoustic qualities.” The generative AI model 112 can refine the input text into a request that reads “Find a material for an exterior finish material made of a sustainable material. The sustainable material is designed for use in external walls in commercial and residential buildings. The main features of the sustainable material are sustainability and acoustic qualities.” The refined text can then be converted into dynamically generated query 254, which stores the same or similar information in one or more data structures that are understood by the materials engine 256.

According to some embodiments, the materials engine 256 can implement multiple functionalities, including a search by traversal of knowledge graph by language model 262 that is associated with a pre-generated materials knowledge graph 258. The materials engine 256 can also implement a search by vector similarity 264 that is associated with vector embeddings of the materials 260. According to some embodiments, the materials agent 256 utilizes the large language model processing unit 270 to integrate material data retrieved from the pre-generated materials knowledge graph 258, vector embeddings of materials 260, or other material data sources. The integrated material data is retrieved via a material data retrieval module 268 and can be further processed, together with additional evaluation metrics 266, through the large language model processing unit 270 to generate processing outputs 272. According to some embodiments, material data retrieval module 268 describes one or more algorithms by which materials engine 256 can traverse the respective data sets to obtain suitable materials list 274. The processing outputs 272 can include, for example, the suitable materials list 274, estimated performance metrics 276, and options for further actions 278. As necessary, redefined constraints or requirements 282 can be utilized to generate an additional dynamically generated query 254 that can be processed by the materials engine 256 to generate additional processing outputs 272.

According to some embodiments, materials engine 256 can utilize data from material data sources to generate processing outputs 272. An example of a material data source includes the pre-generated materials knowledge graph 258, which stores detailed information about different materials that are available to be incorporated into building assembly designs. Materials engine 256 can navigate the pre-generated materials knowledge graph 258 to search for specific materials, features of materials, etc., which is represented by the traversal of knowledge graph by language model 262. According to some embodiments, materials engine 256 can identify relevant materials using the material data retrieval module 268. The relevant materials can then be passed to the large language model processing unit 270.

Another example of a material data source includes the vector embeddings of materials 260, which represents a data structure in which information associated with materials are embedded into a multidimensional vector space. According to some embodiments, materials engine 256 can search the vector embeddings of materials 260 by vector similarities to identify vectors that match the user requirements and constraints 252 within a particular threshold. In this regard, search by vector similarity 264 enables a process through which materials engine 256 can select suitable materials in the vector space.

Yet another example of a material data source includes additional evaluation metrics 266, which can hold information that may not typically be included in material datasets (e.g., the pre-generated materials knowledge graph 258, the vector embeddings of materials 260, etc. ,). In one embodiment, a user may import additional material data generated from simulations, analyses performed in external software, or results from physical experiments. For example, when evaluating stone cladding systems for use in coastal construction, the user may import data related to saltwater saturation over time and micro-cracking due to freeze-thaw cycling. This data may be obtained from prior field studies, environmental chamber testing, etc., performed in third-party software or experimental setups. Because such parameters are specialized, the previously discussed datasets may not include such parameters. In such cases, the additional evaluation metrics 266 can be introduced. As shown in FIG. 2B, the evaluation metrics 266 are accessible to the materials engine 256. Accordingly, the additional evaluation metrics 266 can be used to provide an alternative approach for evaluating materials based on simulations, analyses, and so on. Once identified, the material data retrieval module 268 retrieves the stored material data and passes the stored material data to the large language module processing unit 270.

As described herein, materials engine 256 acquires data from various material data sources, such as the pre-generated materials knowledge graph 258, the vector of embeddings of materials 260, the additional evaluation metrics 266, and/or other material data sources not illustrated in FIG. 2B. As the data types across such material data sources can be inconsistent, the large language model processing unit 270 can be employed. In particular, the large language model processing unit 270 can combine retrieved material properties from the different material data sources, and then generate the processing outputs 272 based on the retrieved material properties.

According to some embodiments, the processing outputs 272 can be displayed to the user via user interface 214, and can include a suitable materials list 274 that displays suggestions of suitable materials from the available datasets that meet the user design and requirements constraints 256. The processing outputs 272 can also include estimated performance metrics 276 that reflect an overall performance of the updated building assembly design (e.g., based on adjustments to the materials of which the building assembly design is composed). The processing outputs 272 can further include options for further actions 278, which can be used to prompt the user to replace specific materials, establish redefined constraints or requirements 282, indicate that another iteration of the design process is needed, or the like.

Turning back now to FIG. 1, according to some embodiments, the endpoint device 102 can represent a computing device (e.g., a rack server, a blade server, a tower server, etc.). As shown in FIG. 1, the software application 104 can interface with one or more databases 108 that are implemented by the server device 110 (and/or other entities not illustrated in FIG. 1), which can be used to train generative AI models 112, store design data, and so on. As described herein, the server device 110 can be configured to receive different task requests from the software application 104. The task requests can include, for example, generating, based on user design requirements and constraints 252, a dynamically generated query 254, and any elements of processing output 272, such as a suitable materials list 274, estimated performance metrics 276, or options for further actions 278.

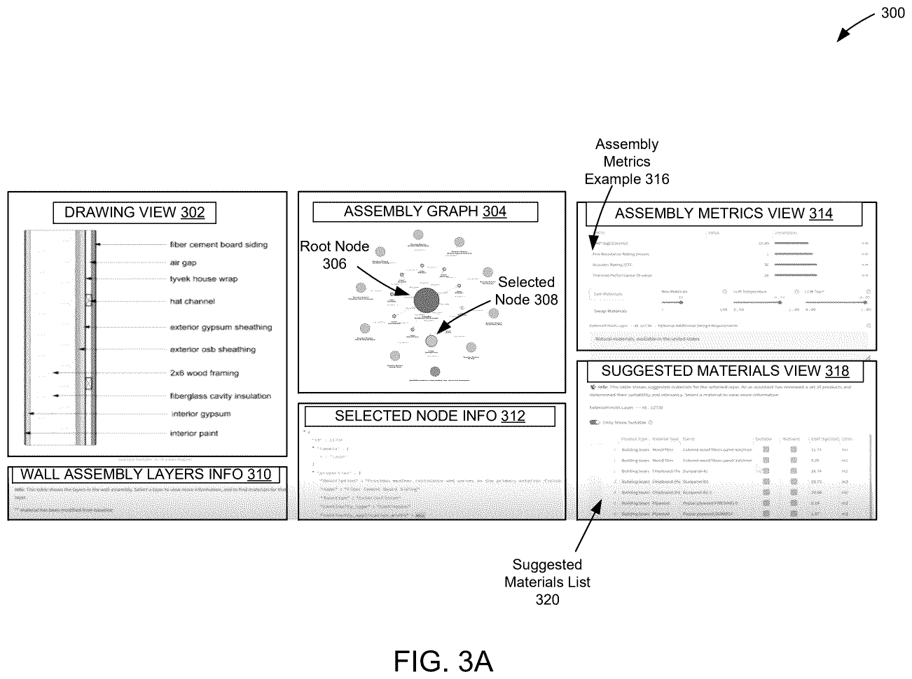

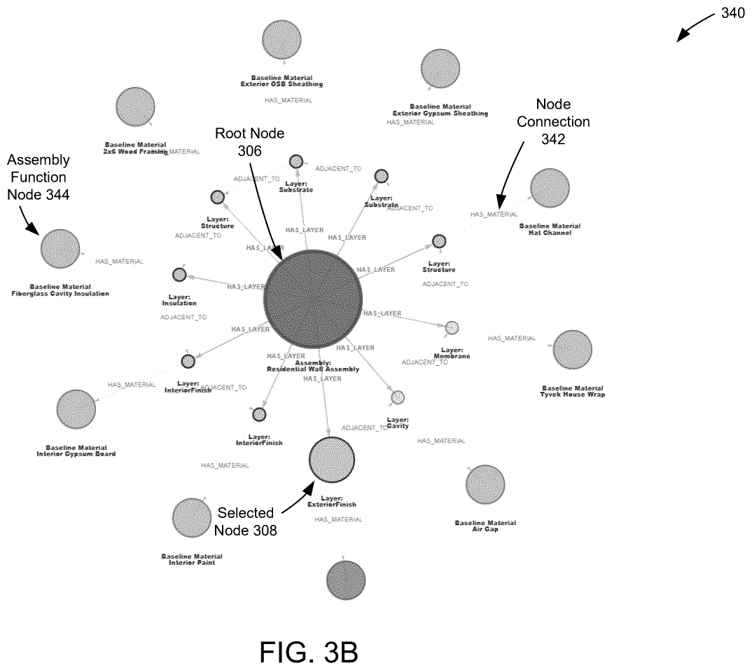

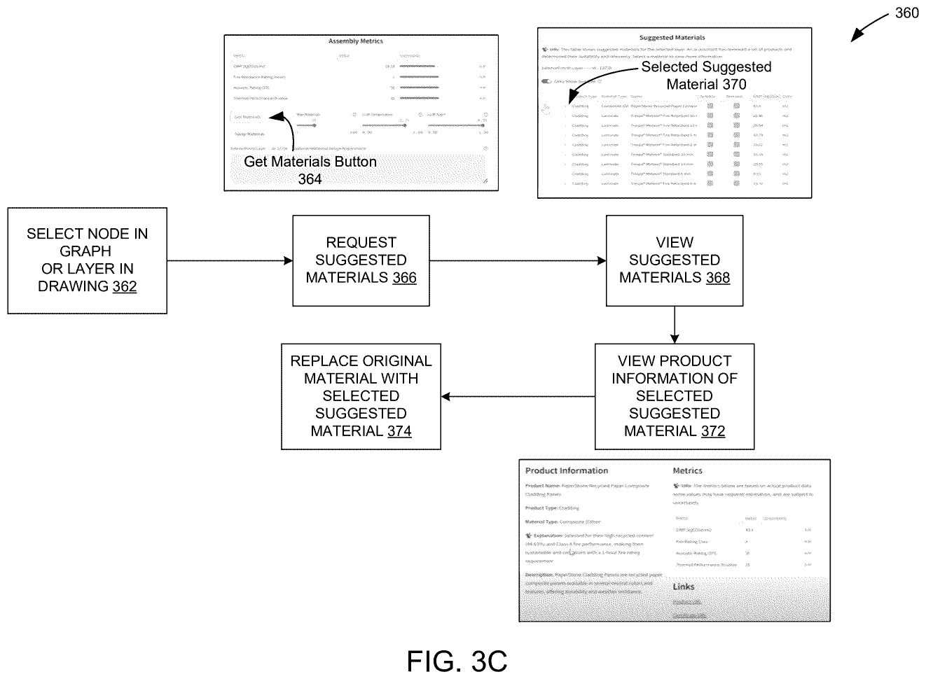

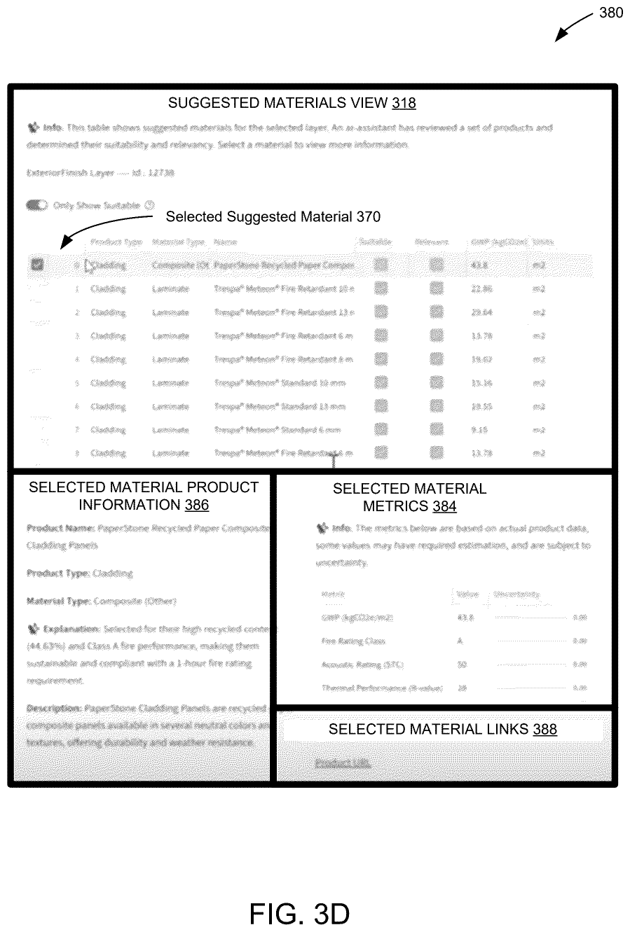

In response, the server device 110 can perform different analyses, e.g., using the databases 108, one or more generative AI models 112, etc., to generate responses to the task requests. The server device 110 can provide the responses back to the software application 104, which can then be displayed to the user by way of different user interfaces 214. A more detailed explanation of the functionality of the user interfaces 214 and further examples of processing output 272 is provided below in conjunction with FIGS. 3A-3D.

According to some embodiments, the generative AI models 112 can be trained using extensive datasets of vector embeddings of materials 260, pre-generated materials knowledge graph 258, assembly drawings, assembly graphs, and the like. It is noted that the foregoing examples are not meant to be limiting, and that the generative AI models 112 can be trained based on any amount, type, form, etc., of information, at any level of granularity, consistent with the scope of this disclosure.

It will be appreciated that the endpoint devices 102, the server devices 110, the databases 108, and the generative AI models 112 described in conjunction with FIG. 1 are illustrative, and that variations and modifications are possible. The connection topologies, including the number of CPUs and memories, may be modified as desired, and, in certain embodiments, one or more components shown in FIG. 1 not be present, or may be combined into fewer components. For example, in some embodiments, the endpoint device 102 can be configured to implement the techniques described herein so that interaction with one or more server devices 106 is not required. Further, in certain embodiments, one or more components shown in FIG. 1 may be implemented as virtualized resources in one or more virtual computing environments and/or cloud computing environments.

### User Interfaces

FIG. 3A illustrates an example user interface 300 that can be displayed by the software application 104 after a user has specified a first user input 202 and an assembly graph representation 206 has been generated. As shown in FIG. 3A, the user interface 300 includes a drawing view 302 and wall assembly layers information 310. As shown in FIG. 3A, an assembly graph view 304 corresponds to the drawing view 302 and displays a selected node 308 and a root node 306. As shown in FIG. 3A, the user interface 300 further includes an assembly metrics view 314 that includes an assembly metrics example 316. Additionally, the user interface 300 includes selected node information 312 and a suggested materials view 318, which includes a suggested materials list 320.

According to some embodiments, the drawing view 302 provides a side-view representation of an aspect of the building assembly design—specifically, the different material layers of a given wall assembly included in the building assembly design. As shown in FIG. 3A, each material layer is displayed with a specified thickness, associated material, location, etc., relative to the wall assembly. Wall assembly layers information 310 provides more detailed information, such as specific details on one or more of the individual layers displayed, selected, etc., in the drawing view 302.

According to some embodiments, the assembly graph view 304 provides an assembly graph representation of the wall assembly displayed in the drawing view 302. As shown in FIG. 3A, the assembly graph view 304 displays the root node 306, which corresponds to the wall assembly as a whole, the selected node 308, and additional nodes such as the material nodes and functional nodes described herein. According to some embodiments, a selection of the root node 306 causes the selected node information 312 to display collective information about the wall assembly. As shown in FIG. 3A, the selected node information 312 provides more detailed information, such as specific details on one or more of the nodes displayed, selected, etc., in the assembly graph view 304. Further discussion of the assembly graph view 304 is provided below in conjunction with FIG. 3B.

In some embodiments, assembly metrics view 314 provides an overall summary of the wall assembly design, building assembly design, etc., including metrics such as Global Warming Potential (GWP), fire resistance, acoustic ratings, thermal performance, operating temperatures, and the like. For example, assembly metrics example 316 highlights the specific metric of fire resistance. It is noted that the foregoing examples are not meant to be limiting, and that the assembly metrics view 314 can include any amount, type, form, etc., of information, at any level of granularity, consistent with the scope of this disclosure.

Additionally, the suggested materials view 318 displays a suggested materials list 320 that contains suggested materials for replacing different materials in the wall assembly. As shown in FIG. 3A, suggested materials list 320 can be organized by relevance and includes details such as product type, material type, name, GWP, and associated material units. Again, it is noted that the foregoing examples are not meant to be limiting, and that the suggested materials view and the suggested materials list 320 can include any amount, type, form, etc., of information, at any level of granularity, consistent with the scope of this disclosure.

FIG. 3B illustrates a detailed view of an assembly graph representation 340, which, as shown, includes a root node 306, selected node 308, a node connection 342, and an assembly function node 344. The root node 306 corresponds to the assembly graph representation 340 and contains information that is relevant to the wall assembly, such as collective assembly metrics, a location of the assembly graph representation 340 within a larger assembly, etc. The selected node 308 represents a material. The size, shape, or color of the selected node 308 may change based on the contribution of the material to the wall assembly. For example, if one of the assembly metrics is the requirement for fireproofing and the material/selected node 308 is prone to ignition, then the size of node 308 can be significantly larger relative to other nodes in the assembly graph representation 340.

As shown in FIG. 3B, the node connection 342 represents the connection between the root node 306 and the selected node 308. In general, within the assembly graph representation 340, node connections represent the relationships between materials. For example, for the selected node 308, there are three connections stemming from the selected node 308, indicating that the selected node 308 is associated with two other material nodes in addition to the root node 306. Node connection 342 can represent a physical connection or other types of relationships between material nodes.

According to some embodiments, the assembly function node 344 appears based on user design requirements. Assembly function node 344 indicates how well the assembly graph representation 340, as a whole, meets the specified design criteria. For example, if a user specifies that fireproofing is an important constraint, assembly function node 344 can indicate a level of fireproofing achieved by the assembly and can store specific information about the level of fireproofing. Similarly, if the user requires the assembly to withstand specific climates, such as high humidity, then the assembly function node 344 (or other assembly function nodes) can include information regarding the humidity resistance of the assembly.

FIG. 3C illustrates a detailed view of an example workflow taking place via a user interface 360. In a first step 362, the user can select a node in a graph view. In this step, the user can select an individual material to inspect, whether on the assembly graph or drawing view, and can examine the properties of the material and the effect the material has on the building assembly design. As shown in FIG. 3C, and as described herein, assembly graph nodes that are most relevant, susceptible to replacement, etc., can be visually differentiated from other nodes using different sizes, colors, shapes, etc.

In a following step 366, the user requests suggested materials. The request can be made, for example, by selecting a “get materials” button 364. When the get materials button 364 is selected, the system 100 performs the workflow processes described above in conjunction with FIGS. 2A-2B, where the server device 110 navigates the material data sources and selects relevant materials based on user constraints that have been specified.

As shown in FIG. 3C, in a following step 368, the user can view the suggested materials. In the example illustrated in FIG. 3C, the selected suggested material 370—which is selected by the user—is positioned at the top of the list and is determined to be the most relevant replacement for the previously selected material based on the user constraints.

As shown in FIG. 3C, in a following step 372, the user can then view product information for the selected suggested material 370. Here, the user can examine product information including product name, product types, material types, explanation and description, metrics such as GWP, fire rating class, acoustic rating, thermal performance, and relevant links. When the user has determined that a specific material is most relevant for replacement, an additional step 374, which involves replacing the original material with selected suggested material, is carried out. Accordingly, through the techniques illustrated in FIG. 3C, the user interacts with user interface 360 and can replace materials within building assembly design.

FIG. 3D provides a more detailed view of alternative suggested materials and associated information 380. As shown in FIG. 3D, alternative suggested materials and associated information 380 includes a suggested materials view 318 with a selected suggested material 370, selected material metrics 384, selected material product information 386, and selected material links 388. Suggested materials view 318 contains a list of suggested materials that can include product type, material type, name, suitability level, relevance level GWP, and associated units. The list of suggested materials can be generated based on user constraints, and the materials can be sourced from materials data sets, as described herein.

When the user selects the suggested material 382, selected material metrics 384 can be shown. Selected material metrics 384 can include the fire rating class, GWP, acoustic ratings, thermal performance information, and any other relevant material metrics associated with the selected material 382. Selected material product information 386 can include the product name, product type, material type, explanations, and descriptions. Selected material product information 386 can also include selected material links 388. Accordingly, the user interfaces illustrated in FIG. 3D allow the user to inspect individual suggested materials to determine whether the suggest materials are acceptable to be incorporated into the building assembly design.

### Method for Incorporating Materials Into Building Assembly Designs

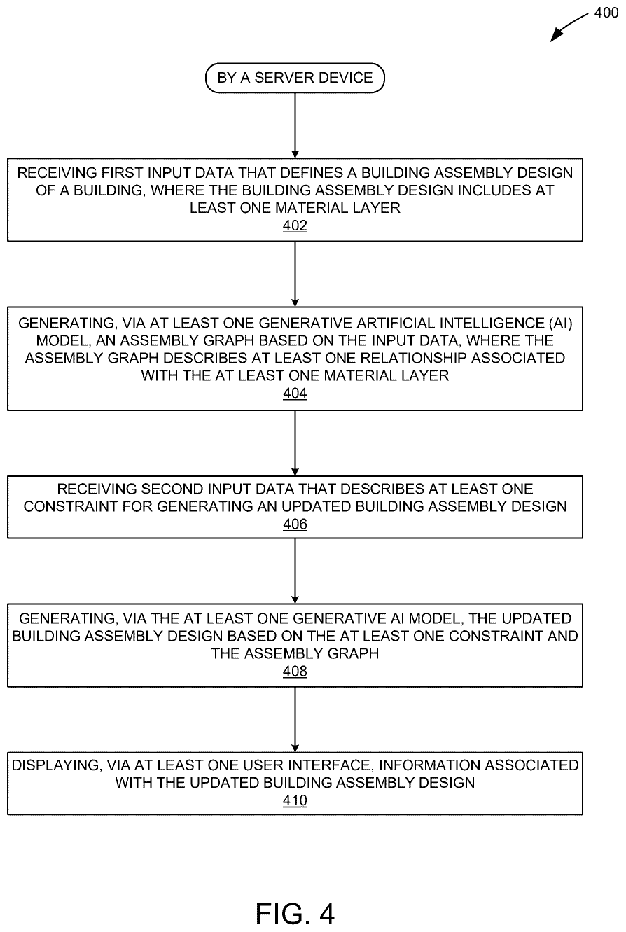

FIG. 4 illustrates a method for incorporating materials into building assembly designs, according to some embodiments. As shown in FIG. 4, the method 400 begins at step 402, where the server device 110 receives first input data that defines a building assembly design, where the building assembly design includes at least one material layer (e.g., as described above in conjunction with FIGS. 1, 2A-2B, and 3A-3D). At step 404, the server device 110 generates, via at least one generative artificial intelligence (AI) model, an assembly graph based on the input data, where the assembly graph describes at least one relationship associated with the at least one material layer (e.g., as described above in conjunction with FIGS. 1, 2A-2B, and 3A-3D). At step 406, the server device 110 receives second input data that describes at least one constraint for generating an updated building assembly design (e.g., as described above in conjunction with FIGS. 1, 2A-2B, and 3A-3D). At step 408, the server device 110 generates, via the at least one generative AI model, the updated building assembly design based on the at least one constraint and the assembly graph (e.g., as described above in conjunction with FIGS. 1, 2A-2B, and 3A-3D). At step 410, the server device 110 displays, via at least one user interface, information associated with the updated building assembly design (e.g., as described above in conjunction with FIGS. 1, 2A-2B, and 3A-3D).

### Computing Device Overview

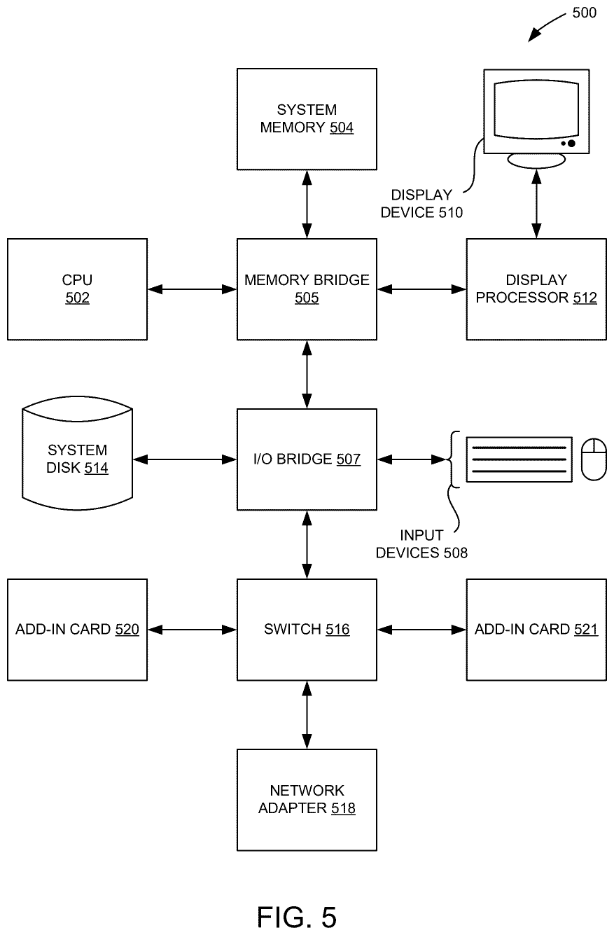

FIG. 5 is a more detailed illustration of a computing device that can implement the functionalities of the entities illustrated in FIG. 1, according to various embodiments. This Figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in FIG. 3 are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCIE), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed embodiments set forth techniques for incorporating materials into building assembly designs through a method of generating, refining, and optimizing building assembly designs with user input data in a software application. In particular, the disclosed techniques set forth a dynamic process for collecting design requirements and constraints from a user and transmitting the information to a server device. The server device then leverages one or more generative AI models to generate an initial assembly graph representation of a building assembly design, where nodes in the assembly graph represent individual materials and corresponding functional properties. The user can select a specific material by interacting with the assembly graph. The software application can suggest specific material nodes of interest that would best benefit from optimization based on the overall impact that the material nodes have on the design, given the user-defined constraints.

In a following step, the software application can suggest alternative materials based on the predefined constraints and assembly goals by leveraging generative AI models. The suggested alternative materials are displayed to the user based on relevance and compliance with the user-defined constraints. After selecting alternative materials, the assembly graph is updated to further-optimize the assembly graph. An additional step involves presenting both the updated assembly and the associated functional parameters of the assembly via an interface, which allows for review and further adjustments. Supplementary data sources can be integrated to further-inform the evaluation of the design constraints and can be used in the one or more generative AI models. Ultimately, the updated assembly designs and associated performance data, including relevant environmental metrics, can be presented to the user via an intuitive interface, supporting ongoing review and adjustment. This integrated approach combines automated design generation, user input, advanced AI processing, and material datasets to deliver a workflow to understand and adjust a building assembly design.

One technical advantage of the disclosed techniques relative to the prior art is that the system reduces errors in the design process by aiding in the research process. By suggesting materials that meet user-defined requirements, the system enables designers to accurately balance a wide variety of trade-offs, functions, and restrictions inherent in building assemblies. This automated approach allows for a more informed evaluation of material layers against critical design constraints, including performance, sustainability, and regulatory compliance, reducing the risk of error-prone manual research. Another technical advantage is that the disclosed techniques consolidate all the necessary knowledge into a single, integrated system. This integration empowers designers to work independently without relying on external experts or additional resources, as the system holds all relevant material data and expertise internally. By aggregating information from diverse databases, industry standards, and design inputs, the system simplifies the decision-making process, ensuring that all the knowledge required for informed material layer selection is readily available in one centralized platform.
1. In some embodiments, a computer-implemented method for incorporating materials into building assembly designs comprises: receiving first input data that defines a building assembly design, wherein the building assembly design includes at least one material layer; generating, via at least one generative artificial intelligence (AI) model, an assembly graph based on the first input data, wherein the assembly graph describes at least one relationship associated with the at least one material layer; receiving second input data that describes at least one constraint for generating an updated building assembly design; generating, via the at least one generative AI model, the updated building assembly design based on the at least one constraint and the assembly graph; and displaying, via at least one user interface, information associated with the updated building assembly design.
2. The computer-implemented method of clause 1, wherein the first input data comprises at least one of image data, video data, or text data.
3. The computer-implemented method of clause 2, wherein the first input data is generated via the at least one generative AI model based on a description of the building assembly design included in at least one of the image data, the video data, or the text data.
4. The computer-implemented method of clause 1, wherein the assembly graph comprises a root node and at least one of at least one material node or at least one function node.
5. The computer-implemented method of clause 4, wherein the assembly graph includes one or more edges between the root node and the at least one of the at least one material node or the at least one function node that describe the at least one relationship associated with the at least one material layer.
6. The computer-implemented method of clause 1, wherein the information comprises at least one of video data, image data, or textual data.
7. The computer-implemented method of clause 1, wherein the at least one generative AI model is trained on at least one dataset of material layers.
8. The computer-implemented method of clause 1, wherein the building assembly design comprises at least one of at least one exterior wall of a building.
9. The computer-implemented method of clause 1, further comprising: receiving, via the at least one user interface, a selection of at least one material layer included in the building assembly design; and displaying, via the at least one user interface, second information associated with the at least one material layer.
10.The computer-implemented method of clause 9, wherein the second information comprises at least one of product specifications associated with the at least one material layer, physical and functional properties associated with the at least one material layer, or procurement options associated with the at least one material layer.
11. In some embodiments, one or more non-transitory computer readable media store instructions that, when executed by one or more processors, cause the one or more processors to incorporate materials into building assembly designs, by performing the operations of: receiving first input data that defines a building assembly design, wherein the building assembly design includes at least one material layer; generating, via at least one generative artificial intelligence (AI) model, an assembly graph based on the first input data, wherein the assembly graph describes at least one relationship associated with the at least one material layer; receiving second input data that describes at least one constraint for generating an updated building assembly design; generating, via the at least one generative AI model, the updated building assembly design based on the at least one constraint and the assembly graph; and displaying, via at least one user interface, information associated with the updated building assembly design.
12.The one or more non-transitory computer readable media of clause 11, wherein the first input data is received via the at least one user interface.
13.The one or more non-transitory computer readable media of clause 11, wherein the information includes at least one metric associated with an overall compliance of the updated building assembly design with at least one building code.
14.The one or more non-transitory computer readable media of clause 11, wherein the second input data is generated based on user interactions directed to the assembly graph.
15.The one or more non-transitory computer readable media of clause 11, wherein the first input data comprises at least one of image data, video data, or text data.
16.The one or more non-transitory computer readable media of clause 15, wherein the first input data is generated via the at least one generative AI model based on a description of the building assembly design included in at least one of the image data, the video data, or the text data.
17.The one or more non-transitory computer readable media of clause 11, wherein the assembly graph comprises a root node and at least one of at least one material node or at least one function node.
18.The one or more non-transitory computer readable media of clause 17, wherein the assembly graph includes one or more edges between the root node and the at least one of the at least one material node or the at least one function node that describe the at least one relationship associated with the at least one material layer.
19.The one or more non-transitory computer readable media of clause 11, wherein the information comprises at least one of video data, image data, or textual data.
20.In some embodiments, a computer system comprises: one or more memories that include instructions, and one or more processors that are coupled to the one or more memories, and that, when executing the instructions, are configured to incorporate materials into building assembly designs, by performing the operations of: receiving first input data that defines a building assembly design, wherein the building assembly design includes at least one material layer; generating, via at least one generative artificial intelligence (AI) model, an assembly graph based on the first input data, wherein the assembly graph describes at least one relationship associated with the at least one material layer; receiving second input data that describes at least one constraint for generating an updated building assembly design; generating, via the at least one generative AI model, the updated building assembly design based on the at least one constraint and the assembly graph; and displaying, via at least one user interface, information associated with the updated building assembly design.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer. ” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for incorporating materials into building assembly designs, the method comprising:
receiving first input data that defines a building assembly design, wherein the building assembly design includes at least one material layer;
generating, via at least one generative artificial intelligence (AI) model, an assembly graph based on the first input data, wherein the assembly graph describes at least one relationship associated with the at least one material layer;
receiving second input data that describes at least one constraint for generating an updated building assembly design;
generating, via the at least one generative AI model, the updated building assembly design based on the at least one constraint and the assembly graph; and
displaying, via at least one user interface, information associated with the updated building assembly design.

2. The computer-implemented method of claim 1, wherein the first input data comprises at least one of image data, video data, or text data.

3. The computer-implemented method of claim 2, wherein the first input data is generated via the at least one generative AI model based on a description of the building assembly design included in at least one of the image data, the video data, or the text data.

4. The computer-implemented method of claim 1, wherein the assembly graph comprises a root node and at least one of at least one material node or at least one function node.

5. The computer-implemented method of claim 4, wherein the assembly graph includes one or more edges between the root node and the at least one of the at least one material node or the at least one function node that describe the at least one relationship associated with the at least one material layer.

6. The computer-implemented method of claim 1, wherein the information comprises at least one of video data, image data, or textual data.

7. The computer-implemented method of claim 1, wherein the at least one generative AI model is trained on at least one dataset of material layers.

8. The computer-implemented method of claim 1, wherein the building assembly design comprises at least one of at least one exterior wall of a building.

9. The computer-implemented method of claim 1, further comprising:
receiving, via the at least one user interface, a selection of at least one material layer included in the building assembly design; and
displaying, via the at least one user interface, second information associated with the at least one material layer.

10. The computer-implemented method of claim 9, wherein the second information comprises at least one of product specifications associated with the at least one material layer, physical and functional properties associated with the at least one material layer, or procurement options associated with the at least one material layer.

11. One or more non-transitory computer readable media storing instructions that, when executed by one or more processors, cause the one or more processors to incorporate materials into building assembly designs, by performing the operations of:
receiving first input data that defines a building assembly design, wherein the building assembly design includes at least one material layer;
generating, via at least one generative artificial intelligence (AI) model, an assembly graph based on the first input data, wherein the assembly graph describes at least one relationship associated with the at least one material layer;
receiving second input data that describes at least one constraint for generating an updated building assembly design;
generating, via the at least one generative AI model, the updated building assembly design based on the at least one constraint and the assembly graph; and
displaying, via at least one user interface, information associated with the updated building assembly design.

12. The one or more non-transitory computer readable media of claim 11, wherein the first input data is received via the at least one user interface.

13. The one or more non-transitory computer readable media of claim 11, wherein the information includes at least one metric associated with an overall compliance of the updated building assembly design with at least one building code.

14. The one or more non-transitory computer readable media of claim 11, wherein the second input data is generated based on user interactions directed to the assembly graph.

15. The one or more non-transitory computer readable media of claim 11, wherein the first input data comprises at least one of image data, video data, or text data.

16. The one or more non-transitory computer readable media of claim 15, wherein the first input data is generated via the at least one generative AI model based on a description of the building assembly design included in at least one of the image data, the video data, or the text data.

17. The one or more non-transitory computer readable media of claim 11, wherein the assembly graph comprises a root node and at least one of at least one material node or at least one function node.

18. The one or more non-transitory computer readable media of claim 17, wherein the assembly graph includes one or more edges between the root node and the at least one of the at least one material node or the at least one function node that describe the at least one relationship associated with the at least one material layer.

19. The one or more non-transitory computer readable media of claim 11, wherein the information comprises at least one of video data, image data, or textual data.

20. A computer system, comprising:
one or more memories that include instructions; and
one or more processors that are coupled to the one or more memories and,
when executing the instructions, are configured to incorporate materials into building assembly designs, by performing the operations of:
receiving first input data that defines a building assembly design, wherein the building assembly design includes at least one material layer;
generating, via at least one generative artificial intelligence (AI) model, an assembly graph based on the first input data, wherein the assembly graph describes at least one relationship associated with the at least one material layer;
receiving second input data that describes at least one constraint for generating an updated building assembly design;
generating, via the at least one generative AI model, the updated building assembly design based on the at least one constraint and the assembly graph; and
displaying, via at least one user interface, information associated with the updated building assembly design.
